(19) United States
(12) Patent Application Publication
(10) Pub. No.: US 2009/0117952 A1
(43) Pub. Date: May 7, 2009

(54) Mobile phone

(75) Inventors: Chih-Hung Chuang, Taipei City (TW); Chen-Yang Wu, Taipei City (TW)

Correspondence Address: QUINTERO LAW OFFICE, PC, 2210 MAIN STREET, SUITE 200, SANTA MONICA, CA, 90405, US

(73) Assignee: ASUSTEK COMPUTER INC., Taipei City (TW)

(21) Appl. No.: 12/255,586

(22) Filed: Oct. 21, 2008

(30) Foreign Application Priority Data
Nov. 1, 2007 (TW) TW96141162

(51) Int. Cl. H04M 1/00

(52) U.S. Cl. 455/575.1

(57) ABSTRACT

The invention provides a first component, a second component and a rotation component. The rotation component has a first pivotal portion, a second pivotal portion and a connection portion. The first and second pivotal portions are located at the two ends of the connection portions and are pivotally connected to the first and second components. Thus, the state of the mobile phone may be switched between an open state and a closed state.

### BACKGROUND OF THE INVENTION

1. Field of the Invention

The invention relates to a mobile phone and, more particularly, to a mobile phone with a rotation component.

2. Description of the Related Art

As shown in FIG. 1A and FIG. 1B, a common flip type mobile phone 10 usually has a master screen 11 and a slave screen 12. When a mobile phone 10 is opened (as shown in FIG. 1A), a user may operate different function via the master screen 11. In addition, when the mobile phone is closed (as shown in FIG. 1B), an image may be displayed by the slave screen 12. A flip type mobile phone mostly has more than two screens, which causes the thickness of the mobile phone to increase and a high manufacture cost.

As shown in FIG. 2, another common slide type mobile phone 20 only has a screen 21. However, the extension range of the sliding mechanism of the slide type mobile phone 20 is limited, and therefore, the room for disposing the key 22 is little. On the other hand, the slide type mobile phone 20 only may slide in a horizontal direction (which is shown by the arrow in FIG. 2), and it is opened without a proper slope angle like that the flip type mobile phone 10 has (as shown in FIG. 1A). Thus, when a user answers the phone, he is not comfortable.

### BRIEF SUMMARY OF THE INVENTION

An embodiment of the invention discloses a mobile phone including a first component, a second component and a rotation component. The first component has a first plane and a screen disposed on the first plane. The second component has a second plane and a plurality of keys disposed on the second plane. The rotation component has a first pivotal portion, a second pivotal portion and a connection portion. The first and second pivotal portions are located at the two ends of the connecting portion and are pivotally connected to the first and second components to allow the state of the mobile phone to be switched between an open state and a closed state. When the mobile phone is in the closed state, the first component covers the second plane. When the state of the mobile phone is switched to the closed state from the open state, the first and second components rotate relatively to the rotation component to form a slope angle between the first and second planes.

In one embodiment, when the mobile phone is in an open state, the slope angle is about 165 degrees.

In one embodiment, when the mobile phone is in an open state, the rotation component is in a limit position and abuts against the second component.

In one embodiment, the first and second pivotal portions are parallel to each other.

In one embodiment, the rotation component has an approximate rectangular structure.

In one embodiment, the mobile phone further includes two elastic elements whose torque is equal. The elastic elements are disposed on the first and second pivotal portions, respectively, to keep the first and second components parallel in moving.

In one embodiment, the mobile phone further includes a connection cable, and the rotation component further has a through hole. The connection cable passes through the through hole and is electrically connected to the first and second components.

These and other features, aspects, and advantages of the present invention will become better understood with regard to the following description, appended claims, and accompanying drawings.

### BRIEF DESCRIPTION OF THE DRAWINGS

FIG. 1A and FIG. 1B are schematic diagrams showing a flip type mobile phone;

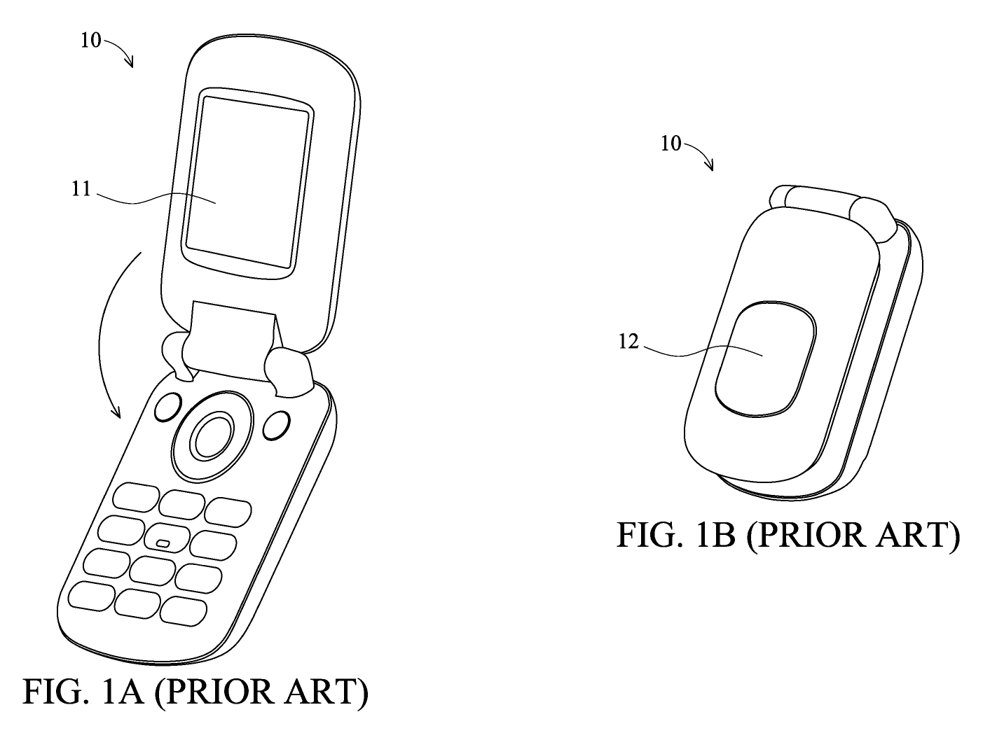

FIG. 2 is a schematic diagram showing a slide type mobile phone;

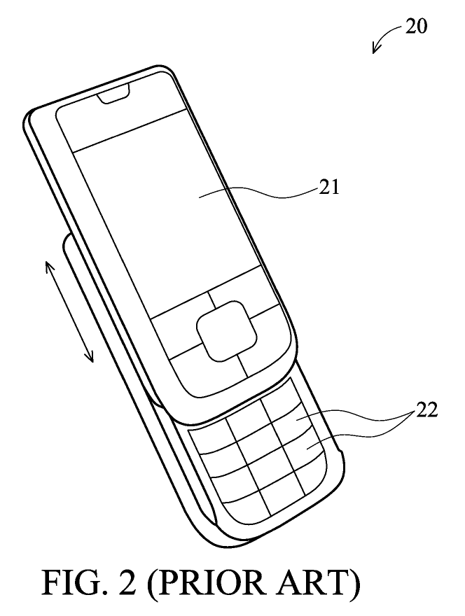

FIG. 3 is a schematic diagram showing a mobile phone of an embodiment of the invention;

FIG. 4 is a schematic diagram showing a mobile phone of an embodiment of the invention in a closed state;

FIG. 5 is a schematic diagram showing that the first component is away from the second plane; and

FIG. 6 is a schematic diagram showing the mobile phone of an embodiment of the invention in an open state.

### DETAILED DESCRIPTION OF THE EMBODIMENTS

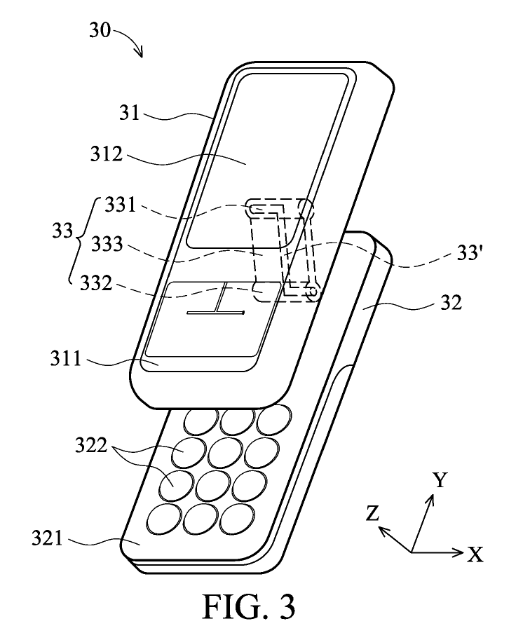

As shown in FIG. 3, the mobile phone 30 of the embodiment mainly includes a first component 31, a second component 32 and a rotation component 33. A screen 312 is disposed on the first plane 311 of the first component 31, and a plurality of keys 322 are disposed on the second plane 321 of the second component 32. The second plane 321 faces the first component 31. As shown in FIG. 3, the first component 31 and the second component 32 are connected to each other via the rotation component 33 to allow the state of the mobile phone 30 to be switched between an open state and a closed state. In addition, the rotation component 33 has a through hole 33′ therein. In the embodiment, the flexible ribbon cable or other connecting cable passes through the rotation component 33 via the through hole 33′ to electrically connect the first component 31 to the second component 32.

As shown in FIG. 3, the rotation component 33 has an approximate rectangular structure and includes a first pivotal portion 331, a second pivotal portion 332 and a connection portion 333. The first pivotal portion 331 and the second pivotal portion 332 are parallel to each other and are located at the two ends of the connection portion 333 to pivotally connect the first component 31 to the second component 32. The rotation component 33 may act as an active connecting rod for allowing the first and second components 31 and 32 to move relatively thus to achieve the functions of opening and closing.

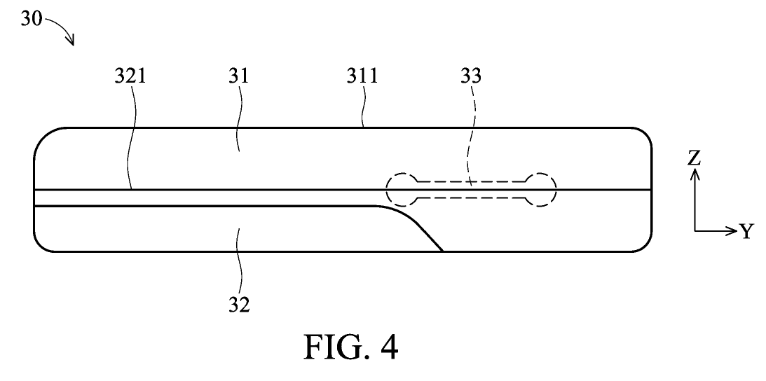

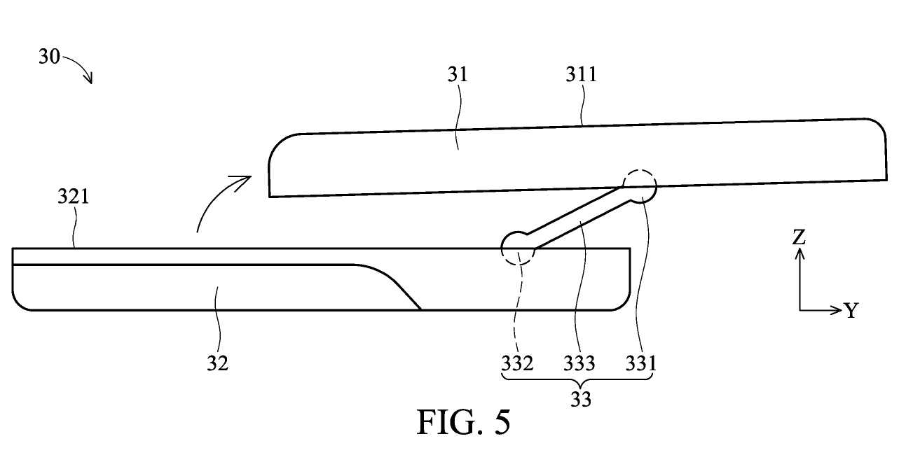

As shown in FIG. 4, when the mobile phone 30 is not used and in a closed state, the first component 31 is superposed at the second component 32. The second plane 321 of the second component 32 is covered by the first component 31 and is about parallel to the first plane 311. As shown in FIG. 5, when a user wants to use the mobile phone 30, he may lift the first component 31 in upper right direction in FIG. 4. Thus, the first component 31 may move relatively to the second component 32 via the rotation component 33 to allow the first component 31 to be away from the second plane 321. In the embodiment, two elastic elements (such as torsional spring) whose torque is equal are disposed at the first pivotal portion 331 and second pivotal portion 332, respectively. Thus, the first component 31 and the second component 32 may approximately be kept parallel in moving (as shown in FIG. 5).

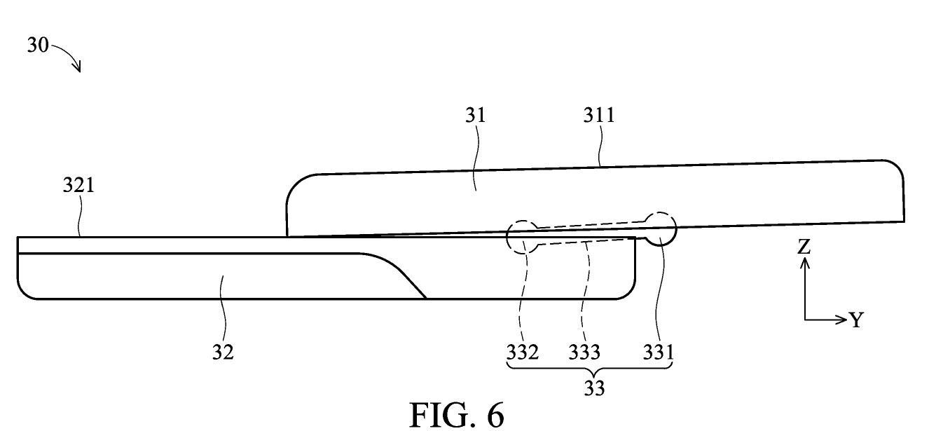

As shown in FIG. 6, when the first component 31 moves to a closed position relatively to the second component 32, the rotation component 33 is located at a limit position and abuts against the second component 32. At that moment, a slope angle (about 165 degrees) is formed between the first plane 311 of the first component 31 and the second plane 321 of the second component 32. Thus, a user may answer a phone conveniently and comfortably.

To sum up, an embodiment of the invention provides a mobile phone including a first component, a second component and a rotation component. The first and second components are pivotally connected to the rotation component, respectively, and may move relatively to each other to switch the state of the mobile phone between an open state and a closed state. The mobile phone of the invention is different from the conventional flip type mobile phone or slide type mobile phone, and it has a low cost and is used conveniently.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A mobile phone comprising:
a first component having a first plane and a screen disposed on the first plane;
a second component having a second plane and a plurality of keys disposed on the second plane; and
a rotation component having a first pivotal portion, a second pivotal portion and a connection portion, wherein the first pivotal portion and the second pivotal portion are provided at the two ends of the connection portion and are pivotally connected to the first component and the second component, respectively, to switch the state of the mobile phone between an open state and a closed state;
wherein when the mobile phone is in the closed state, the first component covers the second plane, and when the state of the mobile phone is switched to the open state from the closed state, the first component and the second component rotate relatively to the rotation component to form a slope angle between the first plane and the second plane.

2. The mobile phone according to claim 1, wherein the slope angle approximately is 165 degrees.

3. The mobile phone according to claim 1, wherein when the mobile phone is in the open state, the rotation component is located at a limit position and abuts against the second component.

4. The mobile phone according to claim 1, wherein the first pivotal portion and the second pivotal portion are parallel to each other.

5. The mobile phone according to claim 1, wherein the rotation component has an approximate rectangular structure.

6. The mobile phone according to claim 1, wherein the rotation component further has a through hole, and a connection cable passes through the through hole and is electrically connected to the first component and second component.
